(19) United States
(12) Patent Application Publication
(10) Pub. No.: US 2016/0234219 A1
(43) Pub. Date: Aug. 11, 2016

(54) USER ADAPTIVE METHOD AND SYSTEM FOR CONTROLLING MOBILE DEVICE

(71) Applicant: MARKANY INC., Seoul (KR)

(72) Inventors: Sang In HAN, Seoul (KR); Sung Gon MUN, Seoul (KR); Kyu Won LEE, Seoul (KR); Jong Uk CHOI, Seoul (KR)

(21) Appl. No.: 15/011,243

(22) Filed: Jan. 29, 2016

(30) Foreign Application Priority Data
Feb. 10, 2015 (KR) 10-2015-0020147

(51) Int. Cl. H04L 29/06; H04W 4/02

(52) U.S. Cl. CPC H04L 63/101; H04W 4/021; H04L 63/20; H04L 63/1416

(57) ABSTRACT

The present invention provides a method for controlling a mobile device adaptively to the user by collecting and analyzing the behavior pattern of the users of the mobile devices, and generating the suitable policy for each of the users. The method may comprise gathering, by the mobile device, behavior patterns of the user, sending, by the mobile device, information about the gathered behavior patterns to an analysis device, analyzing, by the analysis device, the information about the behavior patterns, generating, by the analysis device, media control information based on the behavior patterns and access authority of the user by referring to a management table comprising a list of one or more mobile devices and one or more information about behavior patterns, sending it, by the analysis device, to the mobile device, and controlling the mobile device based on the media control information.

### RELATED APPLICATIONS

This application claims under 35 U.S.C. §119(a) the benefit of Korean Patent Application No. 10-2015-0020147, filed on Feb. 10, 2015, which is herein incorporated by reference in its entirety.

### BACKGROUND

1. Field

The present invention relates to a user adaptive method and system for controlling mobile device. Specifically, the present invention relates to a method and system for controlling mobile device adaptively depending on the user using the mobile device.

2. Background

The present society, empowered by the steady technological innovation and the development of science, entered into a new information-oriented society, resulting in the smart work expanded to not only the advanced countries but also governments and private companies of the developing countries, and most of the documents are managed and transmitted in digital forms.

In addition, recently the smartphones equipped with a high-performance processor and a bulk memory, and which users can freely install applications on are rapidly coming into wide use.

A smartphone integrates schedule management and data communication functions such as fax transmissions and receptions, Internet access, etc. into a cellphone function, and unlike the existing cellphone using given functions only, smartphones enable the following: hundreds of various applications (application programs) can be installed, added or deleted by the user as desired; it is possible to directly access the Internet using the wireless Internet and moreover to access with various methods using various browsing programs; the user can directly make the application desired; the user can establish the suitable interface through various applications; and it is possible to share application between smartphones with the same operation systems (OS). For these reasons, smartphones are rapidly coming into wide use in the cell phone market.

Due to smartphone propagation, recently, almost all of the life-wide work or services such as office work, payment service, certificate issuance, banking, electronic commercial transactions, etc., are done through online and computerized environment. In such an online and computerized environment, digital contents are target of the generation, viewing, storage, editing, transmitting, etc. of information. Here, digital contents may mean various form of digital information including an image or texts, multimedia, etc., for example, digital documents, video, etc.

Moreover, as another phenomenon of the current IT industry, through changes of various devices, the existing computer system is being introduced to mobile devices such as smartphones, tablet PC, etc. and now to various mobile devices. Various micro devices including, as a representative example, iWatch of Apple, Google Glasses of Google, and more over micro camera, voice recorders, etc. are released on the market.

As such, mobile information communication devices such as notebook computer, table PC, smartphones, micro devices, etc. are widely used, and thus BYOD (Bring your own device) environment of using the mobile information communication device privately owned by the employees in the company work is made, and is expanding rapidly. Since introduced for the first time by Intel in 2009, on Feb. 21, 2013, VMware which is a virtualization and cloud solution enterprise, announced “VMware 2013 Asia-Pacific region research on work environment” which reported that the percentage of Korean employees who bring own mobile information communication device to the company was 93 percent. There is an interpretation that as the cases applying BYOD environment are increasing as discussed above, the system is evolving into the phase that the points of contact between private life and the business are increasing and the devices are diversifying, that is, “BYOD ecosystem construction” phase.

If such a BYOD working environment is constructed, effects such as follows can be achieved: employees do not have the inconvenience of carrying many devices for work and for private separately, and thus productivity increases and the company's costs for purchasing device are reduced. However, because an individual carries out the work of the company using the device of his or her own, it is difficult to keep the security of the business, and if security is intensified for this reason, there is a disadvantage of likelihood of infringing privacy. That is, as the number of people using own smart devices for company work increases, the concerns for leak of company information is expanding, and there is also a forecast that they will become the main target of cyber terror.

Security enterprise Dell SonicWALL warned, “As BYOD people increase, new cyber security problems such as company data loss, financial risk, etc. will arise,” and “Through SNS such as Facebook or Tweeter, etc., further evolved viruses will be introduced and the target of cyber terror will be expanded to all enterprises through cloud service regardless of the enterprise being large or small.”

In conclusion, the work system through electronic document provides us with convenience, but unfortunately the damages of the inside information of the business leaking to a third party are incurred, and due to the developing hacking techniques, the inside information of government organization and each of the private enterprises are leaked so the existence and fall of an organization can be at stake. In particular, due to various changes in devices and work environment, such as the construction of BYOD environment using personal mobile information communication device for company work, the target of hacking is no longer restricted to the server, and it can also happen in a user device. Thus, the security based on user device is required.

For such reasons, enterprises are showing great interest in introduction of mobile security and safety solution, and thus there is a trend of introducing technology such as MDM (Mobile Device Management) and DM (Device Management).

### SUMMARY

As described above, for mobile security and safe solution, control for a mobile device is necessary, and for this purpose, use of an existing MDM or DM technology can be considered. However, the technology such as MDM or DM has a disadvantage of controlling by selecting a policy set by a particular rule and then applying the same policy to all users that the MDM system applies. Moreover, at the time of distribution of the policy, the policy is distributed manually and across the board by a specific person (for example, the administrator), and thus there is a problem of not considering individual situation or location, etc.

Thus, the first purpose of the present invention to solve the problem is to provide a method for controlling mobile devices adaptively to the users by collecting and analyzing the behavior patterns of the users of the mobile devices, and generating a suitable policy for each of the users.

In addition, the second purpose of the present invention to solve the problem is to provide a system for controlling mobile devices adaptively to the users by collecting and analyzing the behavior patterns of the users of the mobile devices, and generating a suitable policy for each of the users.

However, the technical subject matter to be achieved of the present invention is not limited to the abovementioned objects, and within the scope not exceeding the idea and the field of the invention, various expansions may be made.

A user adaptive method for controlling mobile device according to an embodiment of the present invention in order to solve the problem described above is characterized by, the method comprising: gathering, by the mobile device, behavior patterns of a user of the mobile device; sending, by the mobile device, information about the gathered behavior patterns to an analysis device; analyzing, by the analysis device, the information about the behavior patterns and generating, by the analysis device, media control information based on the behavior patterns and access authority of the user by referring to a management table comprising a list of one or more mobile devices and one or more information about behavior patterns; sending, by the analysis device, the media control information to the mobile device; and controlling the mobile device based on the media control information.

According to an embodiment, the media control information may comprise, at least one of, range and time information of the service area, information about a function of the mobile device requiring control when the mobile device is in the service area, and information about a behavior pattern corresponding to malicious usage of the mobile device.

According to an embodiment, the one or more information about behavior patterns in the management table may comprise at least one of: massive downloading to a folder; a trace of duplication to another device; installation of a non-attributable application; connecting information to another device; a list of launched applications; external URL access history; and access history to a dangerous country which may lead to installation of an unspecific application.

According to an embodiment, a user adaptive method for controlling a mobile device according to an embodiment of the present invention may further comprise, releasing the control based on the media control information in response to the mobile device leaving service area.

According to an embodiment, a user adaptive method for controlling a mobile device according to an embodiment of the present invention may further comprise, updating the management table in response to the determination that the behavior pattern analyzed by the analysis device corresponds to a new suspicious behavior pattern.

A user adaptive system for controlling a mobile device according to an embodiment of the present invention may comprise: a mobile device; and an analysis device, wherein, the mobile device comprises, gathering unit to gather behavior patterns of a user of the mobile device; sending unit to send information about the gathered behavior patterns to the analysis device; receiving unit to receive a media control information from the analysis device; and control unit to control the mobile device based on the media control information, and wherein, the analysis device comprises, receiving unit to receive the information about the behavior patterns from the mobile device; analysis unit to analyze the information about the behavior patterns; storage unit to store a management table comprising a list of one or more mobile devices and one or more information about behavior patterns; generating unit to generate the media control information based on the analyzed behavior patterns and access authority of the user by referring to the management table; and sending unit to send the media control information to the mobile device.

According to an embodiment, the media control information in the management table may comprise at least one of, range and time information of the service area, information about a function of the mobile device requiring control when the mobile device is in the service area, and information about a behavior pattern corresponding to malicious usage of the mobile device.

According to an embodiment, the one or more information about behavior patterns in the management table may comprise at least one of: massive downloading to a folder; a trace of duplication to another device; installation of a non-attributable application; connecting information to another device; a list of launched applications; external URL access history; and access history to a dangerous country which may lead to installation of an unspecific application.

According to an embodiment, the control unit may release the control based on the media control information in response to the mobile device leaving service area.

According to an embodiment, the analysis unit may update the management table in response to the determination that the behavior pattern analyzed by the analysis unit corresponds to a new suspicious behavior pattern.

According to a user adaptive method and system for controlling mobile device according to an embodiment of the present invention, by gathering and analyzing the behavior pattern of the users of the mobile device, and generating the suitable policy for each of the users, it is possible to control a mobile device adaptively to the user.

That is, by generating the tailored control information for each individual through the analysis of the behavior pattern of the user of the mobile device, it becomes possible to apply adequate policy for each individual, and thus intensified security can be expected. In addition, unlike the prior technology in which policy is distributed manually and across the board by a specific person (for example, the administrator), the present invention considers the specific situation or location of each individual, having advantageous effects of distributing policy for each individual.

However, the effect of the present invention is not limited to the above, and various modifications may be made within the scope of the invention without departing from the idea of the invention.

### BRIEF DESCRIPTION OF THE DRAWINGS

FIG. 1 is a schematic diagram of user adaptive system for controlling mobile device according to an embodiment of the present invention.

FIG. 2 is a flow chart of user adaptive method for controlling mobile device according to an embodiment of the present invention.

FIG. 3 is a detailed block diagram of user adaptive system for controlling mobile device according to an embodiment of the present invention.

### DETAILED DESCRIPTION

Regarding the embodiments of the present invention in this text, particular structural and functional explanations are merely examples for the purposes of explaining the embodiment of the present invention, and the embodiments of the present invention can be carried out in various forms and the present invention shall not be construed as being limited to the embodiments described in this text.

The present invention can have various modifications and forms, and thus specific embodiments are described in this text in detail with examples in drawings. However, this is not to limit the present invention to a specific disclosed form, and the present invention shall be understood to include all modifications, equivalents and substitutes within the idea and the technological scope of the present invention.

The terminology used in the present application is used for the purposes of explaining a specific embodiment only, and it is not intended to limit the present invention. Singular expressions shall include the plural expressions unless expressly meant otherwise in context. In the present application, it shall be understood that the terms such as “comprise” or “have” etc., are intended to indicate the presence of the described feature, number, step, action, component, part or a combination thereof, and do not exclude the presence or possibility of addition of one or more of other features or numbers, steps, actions, components, parts or combinations thereof.

Unless defined otherwise, all terms used here, including the technical or scientific terms, mean the same as understood by a skilled person in the art to which the present invention pertains. Generally used terms, such as terms defined in a dictionary, shall be construed as having the same meaning in the context of the related technology, and unless otherwise defined explicitly in the present application, they shall not be construed as having ideal or excessively formal meaning.

Hereinafter, the preferable embodiment of the present invention will be explained in more detail with reference to the attached drawings. For the identical components on the drawings, identical reference numerals shall be used, and any overlapping description of the identical component shall be omitted.

### Overview

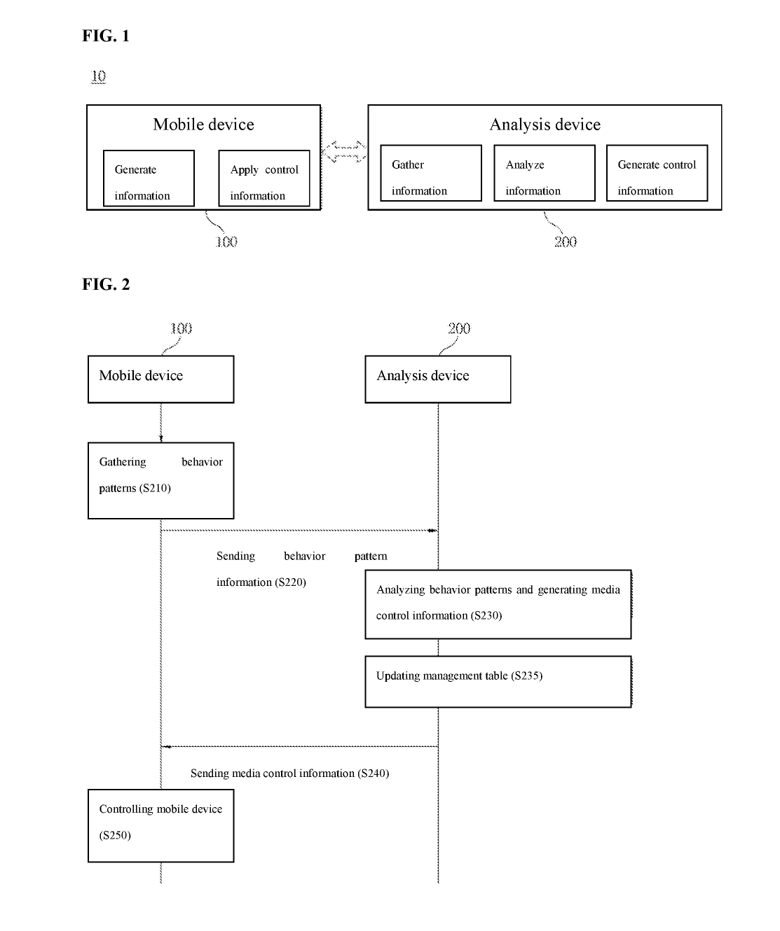

FIG. 1 is a schematic diagram of user adaptive system for controlling mobile device according to an embodiment of the present invention. Hereinafter, with reference to FIG. 1, a user adaptive system (10) for controlling mobile device according to an embodiment of the present invention is schematically explained.

As illustrated in FIG. 1, user adaptive system (10) for controlling mobile device according to an embodiment of the present invention may comprise a mobile device (100) and an analysis device (200).

Firstly, the mobile device (100) can be various devices that a user uses. For example, it can comprise notebook computer, cellphone, tablet PC, navigation, smartphone, PDA (Personal Digital Assistants), PMP (Portable Multimedia Player) or digital broadcasting receiver such as DVB (Digital Video Broadcasting). However, these are merely examples, and the mobile device must be interpreted to comprise all devices capable of communication currently developed and commercialized or to be developed in the future, in addition to the examples described above.

According to a user adaptive system (10) for controlling mobile device according to an embodiment of the present invention, the mobile device (100) can gather behavior patterns of a user of the mobile device and send them to an analysis device (200), and it is possible to control the mobile device (100) based on the media control information received from the analysis device (200).

Analysis device (200) can gather the information about the behavior patterns of the user received from the mobile device (100), analyze the information gathered, and generate media control information suitable for the user.

Thus, according to a user adaptive system for controlling mobile device according to an embodiment of the present invention, the mobile device can be controlled adaptively to the user. That is, by generating the tailored control information for each individual through analysis of the behavior pattern of the user of the mobile device, it becomes possible to apply adequate policy for each individual, leading to an advantageous effects of intensified security. In addition, unlike the prior technology in which policy is distributed manually and across the board by a specific person (for example, the administrator), the present invention considers the specific situation or location of each individual, having advantageous effects of distributing policy for each individual.

### User Adaptive Method for Controlling Mobile Device

FIG. 2 is a flow chart of user adaptive method for controlling mobile device according to an embodiment of the present invention. Hereinafter, with reference to FIG. 2, a user adaptive method for controlling mobile device according to an embodiment of the present invention is specifically explained.

As illustrated in FIG. 2, according to a user adaptive method for controlling mobile device according to an embodiment of the present invention, firstly the mobile device (100) can gather the behavior patterns of the user of the mobile device (100) (Step S210). Then, the mobile device (100) can send the information about the gathered behavior patterns of the user to an analysis device (200).

Here, the information about the behavior patterns of the user may comprise at least one of the below exemplary items:
massive downloading to a folder;
a trace of duplication to another device;
installation of a non-attributable application;
connecting information to another device (For example, it may include connecting information by various communication method such as WiFi, Bluetooth, Near Field Communication (NFC), USB connection etc.);
a list of launched applications;
external URL access history; and
access history to a dangerous country which may lead to installation of an unspecific application (or whether unsafe communication is used or not).

In this regard, if information about massive downloading to a folder and a trace of duplication to another device, etc. is gathered, it can be used as information for determining the likelihood of information leakage about willfulness of the user having the corresponding behavior patterns. In addition, if a non-attributable application is installed, it can be used as information for determining the level of security. Also, if it is confirmed that connection is made with other device by various communication method such as WiFi, Bluetooth, Near Field Communication (NFC), USB connection, etc., it can be used for security level determination as to likelihood of information leakage, hacking, etc. In addition, through the list of executed applications and external access URL record, the main manner of use of the mobile device (100) user can be determined. The access history to a dangerous country which may lead to installation of an unspecific application (or whether unsafe communication is used or not) can be used in determination of security level.

Referring to FIG. 2 again, the analysis device (200) can receive the information about the behavior patterns from the mobile device (100) and by analyzing it, generate media control information (S230). That is, the analysis device (200) can analyze the information about the behavior patterns and generate media control information based on the behavior patterns and access authority of the user by referring to the management table comprising a list of one or more mobile devices and one or more information about behavior patterns.

More specifically, analysis device (200) can store a management table comprising a list of one or more mobile devices and one or more information about behavior patterns. With the analysis device (200), the administrator can allocate access authority for each user for the mobile devices (100) that each of one or more users uses. Thus, the management table may comprise, for example, a list of one or more mobile devices (100) corresponding to each of the users having the access authority. Meanwhile, in response to the determination that the behavior pattern analyzed by the analysis device (200) at the step S230 corresponds to a new suspicious behavior pattern (S235), the analysis device can update the management table to further comprise the analyzed behavior pattern. Thus, the management table may comprise one or more information about behavior patterns that may comprise at least one of the behavior patterns such as the above listed examples.

The analysis device (200) can generate the media control information suitable for the user by analyzing the access authority and the analyzed behavior patterns of the user and the management table in comparison. Here, the media control information may comprise at least one of range and time information of the service area, information about a function of the mobile device requiring control when the mobile device is in the service area, and information about a behavior pattern corresponding to malicious usage of the mobile device.

The spatial range of the area where the service is provided for the mobile device (100) can be varied, and the time when the service is provided for the mobile device (100) can also be set to various units such as specific duration or specific time slot. In addition, the functions of the mobile device requiring control when the mobile device (100) is in the service area can be determined independently of each other. Moreover, a behavior pattern determined to correspond to malicious usage if executed by the mobile device, can be predetermined. In addition, the media control information can be generated and sent in an encrypted form for the protection of data.

The analysis device (200) can send the generated media control information to the mobile device (100) (Step S240), the mobile device (100) receives the media control information and the mobile device (100) can be controlled based thereon (Step S250). Thus, the most suitable control policy for a user, such as varying the range of service area, the function requiring control, or the behavior patterns corresponding to malicious usage depending on the user of the mobile device (100), can be established and distributed.

Meanwhile, the control based on the media control information can be released automatically in response to the mobile device leaving service area. Or, the control based on the media control information can be released, for example, in response to receiving separate media control release information from analysis device (200).

### User Adaptive System for Controlling Mobile Device

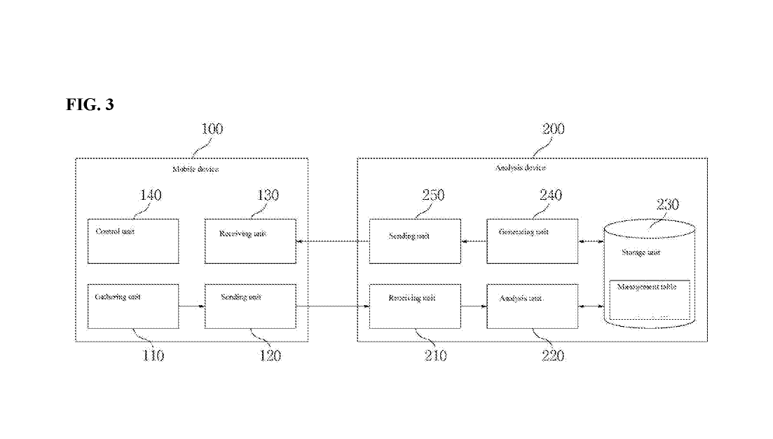

FIG. 3 is a detailed block diagram of user adaptive system for controlling mobile device according to an embodiment of the present invention. Hereinafter, with reference to FIG. 3, a user adaptive system for controlling mobile device according to an embodiment of the present invention is explained in further detail.

Firstly, as illustrated in FIG. 3, a user adaptive system for controlling mobile device according to an embodiment of the present invention may comprise a mobile device (100) and an analysis device (200). In addition, the mobile device (100) may comprise a gathering unit (110), a sending unit (120), a receiving unit (130) and a control unit (140), and the analysis device (200) may comprise a receiving unit (210), an analysis unit (220), a storage unit (230), a generating unit (240) and a sending unit (250).

In further detailed explanation of the constitution of the mobile device (100), the mobile device (100) can gather the behavior patterns of the user and send the gathered information to the analysis device (200). Firstly, the gathering unit (110) gathers the behavior patterns of the user of the mobile device, and the sending unit (120) can send the information about the gathered behavior patterns to the analysis device. In addition, the receiving unit (130) can receive the media control information from the analysis device (200), and the control unit (140) can control the mobile device (100) based on the received media control information.

The analysis device (200) can generate media control information based on the behavior patterns, access authority of the user, etc. by referring to a management table defined based on the gathered information.

The administrator can allocate access authority through the analysis device (200), for each user for the mobile devices (100), and can manage the behavior pattern log received from the users. Moreover, the received behavior pattern logs can be used for generating the media control/release information in accordance with the management table, and the generated media control/release information can be sent to the mobile device (100).

In further detailed explanation of the constitution of the analysis device (200), the receiving unit (210) can receive the information about the behavior patterns from the mobile device (100), and the analysis unit (220) can analyze the information about the received behavior patterns. In addition, the storage unit (230) can store a management table comprising a list of one or more mobile devices and one or more information about behavior patterns, and generating unit (240) can generate the media control information based on the analyzed behavior patterns and access authority of the user of the mobile device (100) by referring to the management table, and the sending unit (250) can send the generated media control information to the mobile device (100).

Here, the media control information may comprise at least one of range and time information of the service area, information about a function of the mobile device requiring control when the mobile device is in the service area, and information about a behavior pattern corresponding to malicious usage of the mobile device. In addition, the media control information can be generated and sent in an encrypted form for the protection of data.

Meanwhile, the one or more information about behavior patterns in the management table may comprise at least one of the below exemplary items:
massive downloading to a folder;
a trace of duplication to another device;
installation of a non-attributable application;
connecting information to another device (For example, it may include connecting information by various communication methods such as WiFi, Bluetooth, Near Field Communication (NFC), USB connection, etc.);
a list of launched applications;
external URL access history; and
access history to a dangerous country which may lead to installation of an unspecific application (or whether unsafe communication is used or not).

Moreover, the control unit (140) may release the control based on the media control information in response to the mobile device (100) leaving service area. For example, the control unit can release control based on the media control information in response to receiving media control release information from analysis device (200).

In addition, the analysis unit (220) may instruct to update the management table stored in the storage unit (230) in response to the determination that the behavior pattern analyzed by the analysis unit corresponds to a new suspicious behavior pattern.

In this regard, the further detailed operations of the user adaptive system for controlling mobile device according to an embodiment of the present invention may be executed according to the user adaptive method for controlling mobile device of the present invention as described above.

A skilled person in the art would recognize that the various exemplary logic blocks, modules, circuits and algorithm steps explained in relation to the embodiments disclosed herein may be implemented as electronic hardware, computer software or a combination of both. In order to clearly exemplify such mutual exchangeability of hardware and software, various exemplary components, blocks, modules, circuits and steps were generally described from the perspective of their functionalities. Whether such functionalities will be implemented as hardware or software depends on the design restriction imposed on the whole system and on the application. A skilled person in the art can implement the explained functionalities in various manners for each application, but such decisions for implementation must not be interpreted to be out of the scope of the present invention.

The method, sequence and/or algorithm explained in relation to the exemplary embodiments disclosed herein may be implemented as hardware directly, software module executed by a processor, or a combination of both. The software module may reside in RAM memory, flash memory, ROM memory, EPROM memory, EEPROM memory, register, hard disk, removable disk, CD-ROM, or storage media of any other form known in the art. The exemplary storage media are coupled to the processor so that the processor can read information from the storage media and record information in the storage media. Otherwise, the storage media may be integrated with the processor.

As above, the present invention is described with reference to a preferable embodiment, but a skilled person in the art would understand that the present invention may be modified and changed variously within the scope of the claims below without departing from the idea of the present invention.

### Explanations of Reference Numerals

100: mobile device

110: gathering unit

120: sending unit

130: receiving unit

140: control unit

200: analysis device

210: receiving unit

220: analysis unit

230: storage unit

240: generating unit

250: sending unit

What is claimed is:

1. A user adaptive method for controlling a mobile device, the method comprising:
gathering, by the mobile device, behavior patterns of a user of the mobile device;
sending, by the mobile device, information about the gathered behavior patterns to an analysis device;
analyzing, by the analysis device, the information about the behavior patterns and generating, by the analysis device, media control information based on the behavior patterns and access authority of the user by referring to a management table comprising a list of one or more mobile devices and one or more information about behavior patterns;
sending, by the analysis device, the media control information to the mobile device;
controlling the mobile device based on the media control information; and
releasing the control based on the media control information in response to the mobile device leaving service area,
wherein the media control information comprises range and time information of the service area, information about a function of the mobile device requiring control when the mobile device is in the service area, and information about a behavior pattern corresponding to malicious usage of the mobile device.

2. The method of claim 1, wherein the one or more information about behavior patterns in the management table comprises at least one of:
massive downloading to a folder;
a trace of duplication to another device;
installation of a non-attributable application;
connecting information to another device;
a list of launched applications;
external URL access history; and
access history to a dangerous country which may lead to installation of an unspecific application.

3. The method of claim 1, further comprising:
updating the management table in response to the determination that the behavior pattern analyzed by the analysis device corresponds to a new suspicious behavior pattern.

4. A user adaptive system for controlling a mobile device, comprising:
a mobile device; and
an analysis device,
wherein, the mobile device comprises,
gathering unit to gather behavior patterns of a user of the mobile device;
sending unit to send information about the gathered behavior patterns to the analysis device;
receiving unit to receive a media control information from the analysis device; and
control unit to control the mobile device based on the media control information and to release the control based on the media control information in response to the mobile device leaving service area,
and wherein, the analysis device comprises,
receiving unit to receive the information about the behavior patterns from the mobile device;
analysis unit to analyze the information about the behavior patterns;
storage unit to store a management table comprising a list of one or more mobile devices and one or more information about behavior patterns;
generating unit to generate the media control information based on the analyzed behavior patterns and access authority of the user by referring to the management table; and
sending unit to send the media control information to the mobile device,
wherein the media control information comprises range and time information of the service area, information about a function of the mobile device requiring control when the mobile device is in the service area, and information about a behavior pattern corresponding to malicious usage of the mobile device.

5. The system of claim 4, wherein the one or more information about behavior patterns in the management table comprises at least one of:
massive downloading to a folder;
a trace of duplication to another device;
installation of a non-attributable application;
connecting information to another device;
a list of launched applications;
external URL access history; and
access history to a country which may lead to installation of an unspecific application.

6. The system of claim 4, wherein the analysis unit updates the management table in response to the determination that the behavior pattern analyzed by the analysis unit corresponds to a new suspicious behavior pattern.
